(19) United States
(12) Patent Application Publication
(10) Pub. No.: US 2007/0097353 A1
(43) Pub. Date: May 3, 2007

(54) Optical device using narrow pass-band filter with multiple transmission peaks in combination with color image sensor for spectral imaging

(76) Inventors: Liebrecht Rudolph Venter, Haymarket, VA (US); David Marcus, Phoenix, AZ (US)

Correspondence Address: Liebrecht R. Venter, 15740 Palmer Lane, Haymarket, VA, 20169, US

(21) Appl. No.: 11/584,811

(22) Filed: Oct. 20, 2006

Related U.S. Application Data
(60) Provisional application No. 60/728,483, filed on Oct. 20, 2005.

(51) Int. Cl. G01C 3/02

(52) U.S. Cl. 356/10

(57) ABSTRACT

The invention is directed to an optical device for imaging of astronomical objects, comprising a filter in front of an imaging sensor, wherein the filter is designed to pass simultaneously at least two narrow-band wave length ranges. Such device enables reduction of exposure time up to the three-fold compared to the time needed for a monochrome sensor.

### CROSS-REFERENCE TO RELATED APPLICATIONS

This application claims benefit of U.S. Provisional Application No. 60/728,483, filed Oct. 20, 2005.

### BACKGROUND OF THE INVENTION

1. Field of the Invention

The present invention relates to an optical device using a narrow pass-band filter with multiple transmission peaks in combination with color image sensors for spectral imaging, e.g., astronomical objects.

2. Discussion of Background Information

Currently, monochrome cameras are used to image objects in the sky, such as, e.g., emission nebulae, galaxies, star fields for photometry and astrometry, and many others. To image in monochrome light involves the use of filters for a specific small wavelength range, e.g. 0.5-15 nm bandwidth range (FWHM). The disadvantage of monochrome cameras is that each filter needs a separate exposure and the combination of multiple spectra is not possible as it cannot be separated once an exposure is taken. Specifically, a separate exposure for each spectral line needs to be taken.

Non-monochrome CCD's and CMOS sensors employ, for example, Bayer matrices and alternative blue, green and red dyes deposited over individual pixels. The use of color CCD's are inefficient compared to the monochrome process as only a fraction of each red, green or blue (RGB) pixels are used for each exposure compared to all the pixels used with a monochrome camera. The loss of resolution obtained with RGB sensors is not recoverable except by combining several exposures and is generally not practical.

### SUMMARY OF THE INVENTION

The present invention relates to an optical device comprising a filter in front of an imaging sensor, wherein the filter is designed to pass simultaneously at least two narrow-band wave length ranges and the sensor is not a monochrome sensor. Such device enables reduction of exposure time up to the three-fold compared to the time needed for a monochrome sensor.

In one aspect of the optical device, the filter is an interference filter, e.g., an etalon.

In another aspect of the optical device, the narrow-band range is up to 80 nm FWHM, preferred up to 50 nm FWHM, and more preferred up to 15 nm FWHM.

In yet another aspect of the optical device, the sensor comprises an RGB Matrix or a CMY Matrix.

In a still further aspect of the optical device, the filter narrow-band transmission peaks are selected from at least one of the group of UV-light, visible green light, visible blue light, visible red light, near infra red, middle infra red. Preferably, the filter comprises transmission peaks for typical element emission lines as present in astronomical objects.

### DETAILED DESCRIPTION OF THE INVENTION

The invention comprises the use of an interference filter inserted in front of an imaging sensor. Such sensor can, for example, be from CMOS or CCD technology. The interference filter is designed to pass multiple spectral lines respectively contained in the blue, red and green part of the visible light in separate pixels, which is read out as separate images. Since the chosen spectral lines of the filter are contained within each of the three colors, separate images are obtained at the same time after a single exposure for each spectral line passed the filter. This is not possible to achieve with a monochrome CCD during a single exposure.

Creating such an interference filter can be done by a filter manufacturer skilled in the art.

Typical examples of the use of the invention are, e.g., as follows:

### EXAMPLE 1

Three spectral lines are chosen:

a) Sulfur [II] (671.7 nm) is selected for the red channel;

b) Neon[I] (587.6 nm) is selected for the green channel;

c) Hydrogen beta [II](486 nm) is selected for the blue channel.

The full-width half-maximum bandwidth (FWHM) is typically in the order of less than 15 nm. However, slightly wider bandwidth is not uncommon for spectral imaging.

The filter is placed in front of the sensor, exposure is taken, and the image is read after the exposure. Since the red, green and blue parts of the spectrum is read out separately, three different images are obtained at once, each comprising of S[II], Ne[I], and H[II] light only. Artificial color is then assigned to each of the images and then combined to establish a false color spectral (S[II], Ne[I], H[II]) image of the object.

### EXAMPLE 2

Spectral lines in the red spectrum can be combined to form a combined red signal. In similar fashion, it can be done for green and blue channels of the sensor. In this case it works as follows:

Hydrogen alpha—H[I]—at 656.4 nm and Nitrogen II—N[II]—at 658 nm are only two nano-meter apart. By choosing the pass-band in the red channel, e.g., a 6 nm FWHM centered at 657 nm, the filter will pass both spectral lines in to the red channel.

Similarly, Oxygen III—O[III]—has two spectral lines close together, namely 500.7 nm and 495.9 nm, which is in the blue/green range for the Bayer matrices as an example for a color CCD. This will result in both blue and green pixels containing the spectral data for these two spectral lines.

In this case the exposure is taken, the data read out and the blue and green channels will contain the combined O[III] spectral lines, while the red channel will contain the H[I] and H[II] spectral lines. The final image is composed in the same way as described in example 1.

### EXAMPLE 3

In the case of narrow band photometry of reasonable fast moving objects in space, the method of the current invention is crucial. A specific application would be in narrow-band photometry of an object in space, such as an asteroid or comet with a rotation rate in the order of a single exposure, typically of at least 6 minutes. Some exposures can range up to an hour or more for dim objects, which makes the invention indispensable. If photometry of such an object needs to be taken, it is only possible to do so by a single exposure using a multiple pass-band filter of the current invention. If a monochrome sensor was used, three different telescopes would be needed to gather spectral data correlated to the same time, which is cumbersome, expensive and impractical.

There is a multitude of possible combinations of spectral lines possible to be imaged in a single exposure and separated and recombined into a spectral false color image as described in the examples.

1. An optical device comprising a filter in front of an imaging sensor, wherein the filter is designed to pass simultaneously at least two narrow-band wave-length ranges and the sensor is not a monochrome sensor.

2. The optical device of claim 1, wherein the filter is an interference filter.

3. The optical device of claim 2, wherein the interference filter is an etalon.

4. The optical device of claim 1, wherein the narrow-band range is up to 80 nm FWHM.

5. The optical device of claim 4, wherein the narrow-band range is up to 50 nm FWHM.

6. The optical device of claim 5, wherein the narrow-band range is up to 30 nm FWHM.

7. The optical device of claim 6, wherein the narrow-band range is up to 15 nm FWHM.

8. The optical device of claim 1, wherein the sensor comprises pixels allocated to different wavelengths from UV to infra-red.

9. The optical device of claim 8, wherein the sensor comprises an RGB Matrix.

10. The optical device of claim 8, wherein the sensor comprises a CMY Matrix.

11. The optical device of claim 1, wherein the filter narrow-band transmission peaks are selected from at least one of the group of UV-light, visible green light, visible blue light, visible red light, near infra red, middle infra red.

12. The optical device of claim 11 where the filter comprises transmission peaks for typical element emission lines as present in astronomical objects.

13. The optical device of claim 1, wherein the filter comprises at least two transmission peaks at UBVRI photometry wavelengths.

14. The optical device of claim 1, wherein the filter comprises at least two transmission peaks for UGRIZ photometry wavelengths.

15. A method of imaging an astronomical object, comprising using an optical device comprising a filter in front of an imaging sensor, wherein the filter is designed to pass simultaneously at least two narrow-band wave-length ranges and the sensor is not a monochrome sensor.
